(19) United States
(12) Patent Application Publication
(10) Pub. No.: US 2011/0185353 A1
(43) Pub. Date: Jul. 28, 2011

(54) Mitigating Problems Arising From Incompatible Software

(76) Inventor: Jack Matthew, San Francisco, CA (US)

(21) Appl. No.: 12/695,018

(22) Filed: Jan. 27, 2010

(51) Int. Cl. G06F 9/445

(52) U.S. Cl. 717/178

(57) ABSTRACT

A method and apparatus for mitigating problems arising from incompatible software is described herein. In one embodiment, a process can be provided to obtain, from an external source, an incompatibility list. The incompatibility list can identify non-priority software incompatible with priority software to be installed or already installed on a system. A determination can be made as to whether the non-priority software from the incompatibility list resides on the system. The process can automatically quarantine one or more files associated with the non-priority software identified in the incompatibility list and which reside on the system.

### FIELD OF THE INVENTION

The field of invention relates generally to computing systems, and, more specifically, to mitigating problems arising from incompatible software.

### BACKGROUND

The average computer has many applications installed and possibly running on it. However, some of these applications may be incompatible with the software which is running on the computer. Furthermore, these incompatible applications may prevent the computer from being usable once new or upgraded software is installed.

### SUMMARY OF THE DESCRIPTION

Mechanisms for mitigating problems arising from incompatible software are described herein. In one embodiment, a process can be provided to obtain an incompatibility list from an external source. The incompatibility list can identify non-priority software which is incompatible with priority software to be installed or already installed on a system. A determination can be made as to whether the non-priority software from the incompatibility list resides on the system. One or more files may be associated with the non-priority software identified in the incompatibility list. If these one or more files reside on the system, they can be automatically quarantined. Systems, methods, and machine readable storage media which perform or implement one or more embodiments are also described.

Other features of the present invention will be apparent from the accompanying drawings and from the detailed description which follows.

### BRIEF DESCRIPTION OF THE DRAWINGS

The present invention is illustrated by way of example and not limited in the figures of the accompanying drawings, in which like references indicate similar elements and in which:

FIG. 1 illustrates a block diagram of an exemplary computer system in which embodiments of the present invention may operate;

FIG. 2 illustrates an exemplary memory in accordance with one embodiment of the present invention;

FIG. 3 illustrates an exemplary memory prior to quarantining a file in accordance with embodiments of the present invention;

FIG. 4 illustrates an exemplary memory after quarantining a file in accordance with embodiments of the present invention;

FIG. 5 illustrates a flow diagram of a method of quarantining incompatible software in accordance with embodiments of the present invention;

FIG. 6 illustrates a flow diagram of a method of verifying an incompatibility list in accordance with embodiments of the present invention;

FIG. 7 illustrates a flow diagram of a method of quarantining incompatible software in accordance with embodiments of the present invention; and

FIG. 8 illustrates a flow diagram of a method of curing incompatible software in accordance with embodiments of the present invention.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Third party software can affect the stability of an operating system. If incompatibilities between third party software and a new version of an operating system are discovered after the physical media containing the operating system installation program has gone to manufacturing or after the operating system has otherwise been released for distribution, it is possible to mitigate the problem by retrieving an up-to-date list of the problematic software (e.g., through a network connection), and quarantining files associated with that software. In embodiment, one or more of the quarantined files can be identified in the retrieved list.

While one illustrative example described herein identifies and quarantines third party software that are incompatible with operating system software, the embodiments described herein can be applied to identify and quarantine any software that is incompatible with any other software to be installed or already installed on a computing system. As used herein, the software that is quarantined has a lower priority relative to the software to which the quarantined software is incompatible. Accordingly, the description herein will use the terms “non-priority software” and “priority software” respectively to reflect the relative priority. It should be understood that, while a particular software may be considered priority software in one instance, the same software may be considered non-priority software in another instance when it is incompatible with software having a higher priority. Priorities can be based on any number of factors and specific to each situation.

In one embodiment, if a network is available, the incompatibility list can be downloaded over a network. In one embodiment, priority software to be installed on a computing system can be downloaded over the network concurrently with an incompatibility list that identifies non-priority software.

In one embodiment, if a network is not available, a computing system can obtain the incompatibility list from installation media on which the priority software also is stored or can use a pre-existing incompatibility list stored in a location accessible to the system (e.g., stored in local memory).

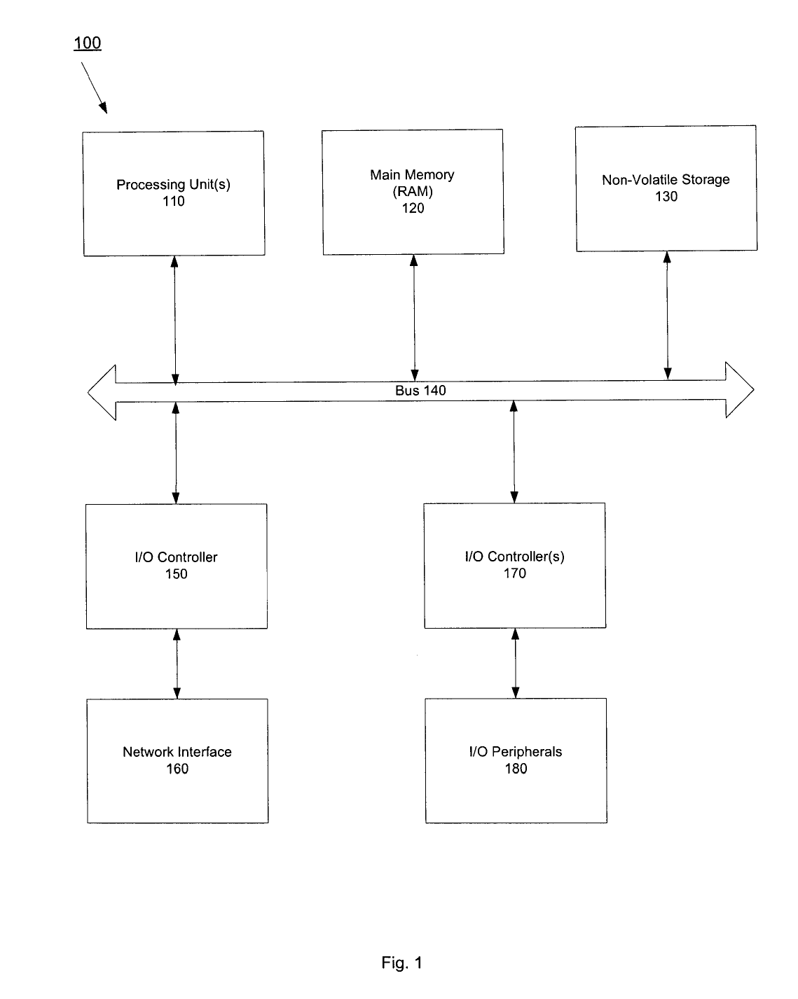

FIG. 1 is a block diagram of an exemplary computer system in which embodiments of the present invention may operate. Computer system 100 includes processing unit(s) 110, main memory (RAM) 120, non-volatile storage 130, bus 140, I/O controller 150, network interface 160, I/O controller 170, and I/O peripherals 180.

Main memory 120 encompasses all volatile or non-volatile storage media, such as dynamic random access memory (DRAM), static RAM (SRAM), or flash memory. Main memory 120 includes storage locations that are addressable by the processing unit(s) 110 for storing computer program code and data structures for determining and quarantining incompatible applications. Such computer program code and data structures also may be stored in non-volatile storage 130. Non-volatile storage 130 includes all non-volatile storage media, such as any type of disk including floppy disks, optical disks such as CDs, DVDs and BDs (Blu-ray Disks), and magnetic-optical disks, magnetic or optical cards, or any type of media, and may be loaded onto the main memory 120. Those skilled in the art will immediately recognize that the term “computer-readable storage medium” or “machine readable storage medium” includes any type of volatile or non-volatile storage device that is accessible by a processor (including main memory 120 and non-volatile storage 130).

Processing unit(s) 110 is coupled to main memory 120 and non-volatile storage 130 through bus 140. Processing unit(s) 110 includes processing elements and/or logic circuitry configured to execute the computer program code and manipulate the data structures. It will be apparent to those skilled in the art that other processing and memory means, including various computer readable storage media, may be used for storing and executing computer program code pertaining to mitigate problems arising from incompatible software.

Processing unit(s) 110 can retrieve instructions from main memory 120 and non-volatile storage 130 via bus 140 and execute the instructions to perform operations described below. Bus 140 is coupled to I/O controller 150. I/O controller 150 is also coupled to network interface 160. Network interface 160 can connect to a network to download an incompatibility list that identifies non-priority software incompatible with priority software to be installed or already installed on computer system 100.

Bus 140 is further coupled to I/O controller(s) 170. I/O controller(s) 170 are coupled to I/O peripherals 180, which may be mice, keyboards, modems, disk drives, optical drives, printers and other devices which are well known in the art.

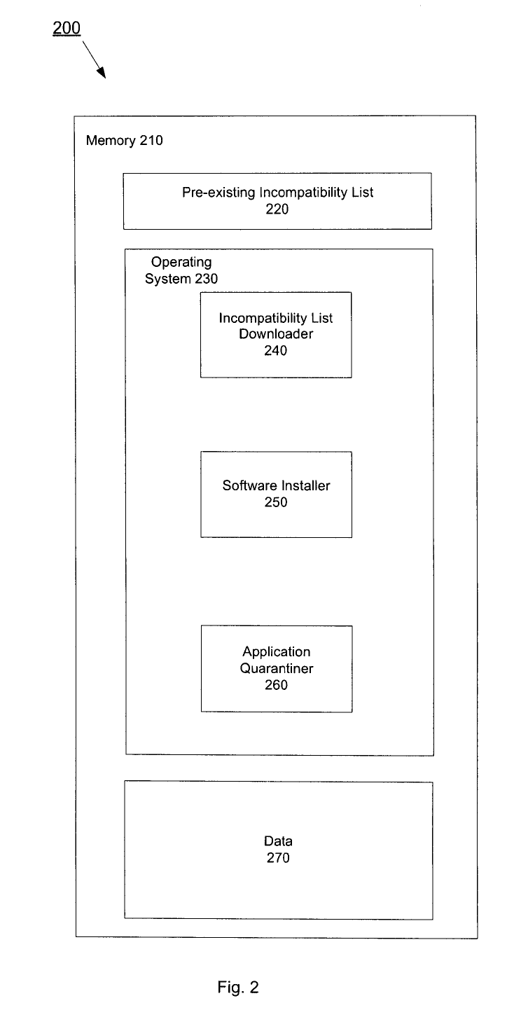

FIG. 2 illustrates an exemplary main memory 120 of FIG. 1 in accordance with one embodiment. Referring to FIG. 2, memory 210 contains pre-existing incompatibility list 220, operating system 230, and data 270. Within operating system 230, there is incompatibility list downloader 240, software installer 250, and application quarantiner 260. In other embodiments, the software components 240, 250, and 260 can be separate from and not part of an operating system. Although memory 210 has been shown as a single memory, this is just one illustrative embodiment. In alternate embodiments, memory 210 can be split into more than one memory.

Pre-existing incompatibility list 220 can identify non-priority software which is incompatible with priority software. In one embodiment, the priority software can already be installed on the system. In an alternate embodiment, the priority software can be software which is to be installed on the system. The non-priority software identified in the incompatibility list can be file names, application names, or other designations that identify incompatible software that needs to be quarantined. Software can be applications or portions thereof, other executables, drivers, or text files to be used by executable software. As used herein, the term “software” can be used in the singular or plural form.

In one embodiment, the non-priority software can include software which prevents the priority software from booting or logging on. In one embodiment, the priority software can be an operating system. In one embodiment, pre-existing incompatibility list 220 can be located in memory 210. In an alternate embodiment, pre-existing incompatibility list 220 can be located in operating system 230. In yet another alternate embodiment, pre-existing incompatibility list 220 can be stored on the installation media on which the priority software also is stored. In this embodiment, the incompatibility list can identify non-priority software incompatible with priority software to be installed at the time the priority software was released.

Incompatibility list downloader 240 obtains an incompatibility list to be used in the quarantining process from an external source. In one embodiment, incompatibility list downloader 240 can determine if a network is available. In this embodiment, if a network is available, incompatibility list downloader 240 can download an incompatibility list over the network. In one embodiment, the incompatibility list can reflect non-priority software which has been tested and found to be incompatible with the priority software. In one embodiment, the priority software can be downloaded over the network concurrently with the incompatibility list.

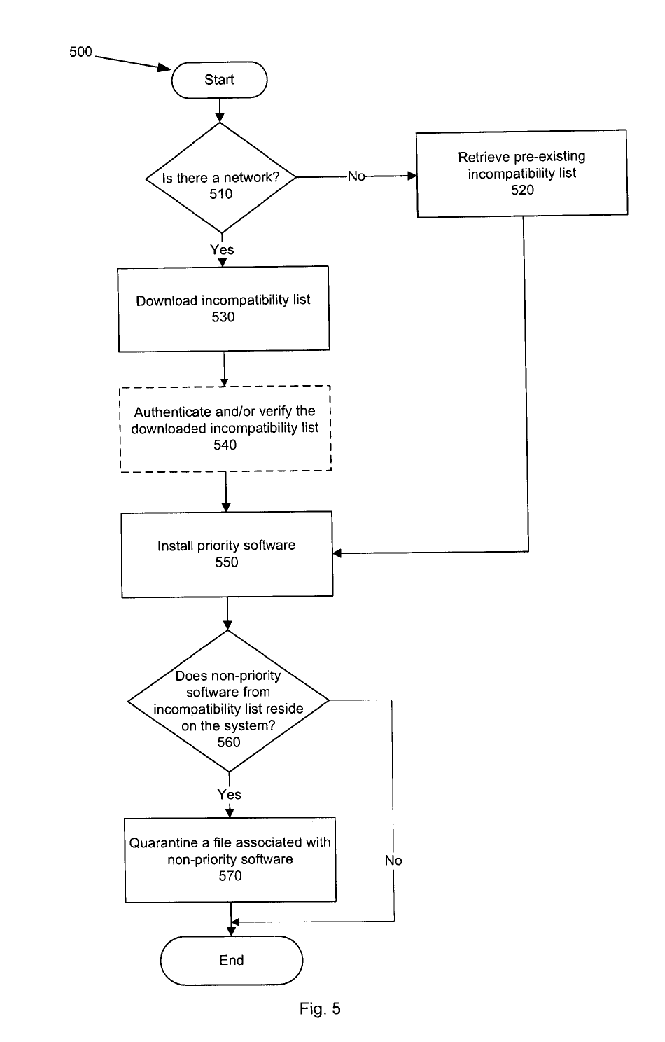

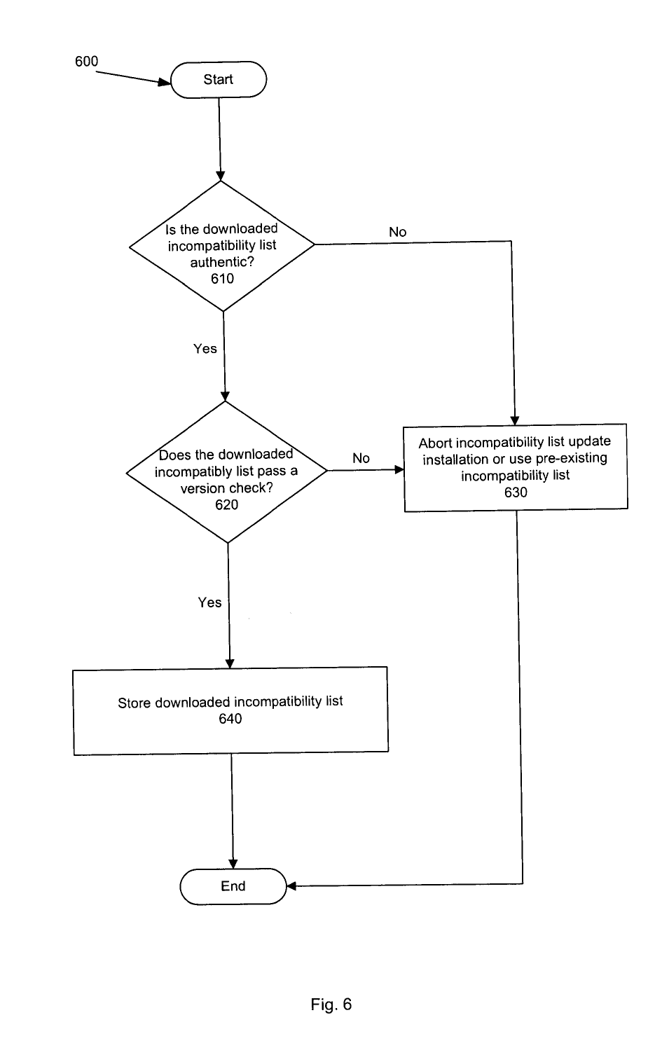

In one embodiment, if a network is not available, incompatibility list downloader 240 can obtain the incompatibility list from pre-existing incompatibility list 220. In an alternate embodiment, incompatibility list downloader 240 can obtain the incompatibility list from operating system 230. In yet another alternate embodiment, if a network is not available, incompatibility list downloader 240 can obtain the incompatibility list from the installation media on which the priority software also is stored. The obtaining of the incompatibility list is described below in conjunction with FIGS. 5 and 6. In one embodiment, once the incompatibility list has been obtained, incompatibility list downloader 240 can send a completion notice to software installer 250.

Upon receiving a completion notice from incompatibility list downloader 240, software installer 250 can install the priority software. In an alternate embodiment, no completion notice is sent from incompatibility list downloader 240. In this embodiment, software installer 250 can install the priority software without waiting for a completion notice. In one embodiment, prior to installing the priority software, software installer 250 can remove any previous software which will be overwritten with the priority software to be installed. In an alternate embodiment, software installer 250 can install priority software which is new on the system. In another alternate embodiment, software installer 250 can update or overwrite software which is already installed on the system. In certain embodiments, software installer 250 can be optional if the priority software is already installed on the system and does not need to be updated or overwritten.

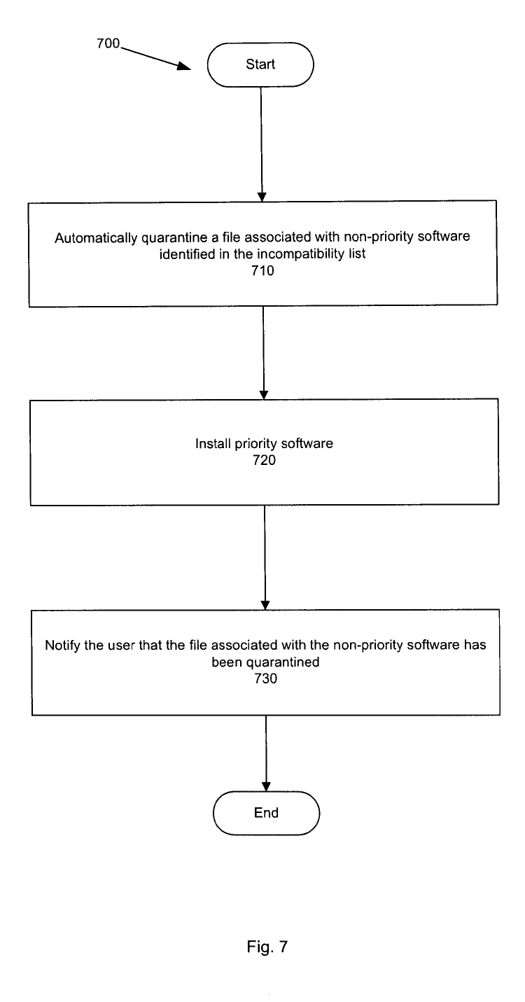

Upon successful installation of the priority software by software installer 250 or if the priority software is already installed on the system, application quarantiner 260 can quarantine the portion of data 270 associated with the incompatible non-priority software. In one embodiment, the quarantined portion of data 270 can be based on the incompatibility list obtained by incompatibility list downloader 240. The quarantine process is described below in conjunction with FIGS. 5 and 7.

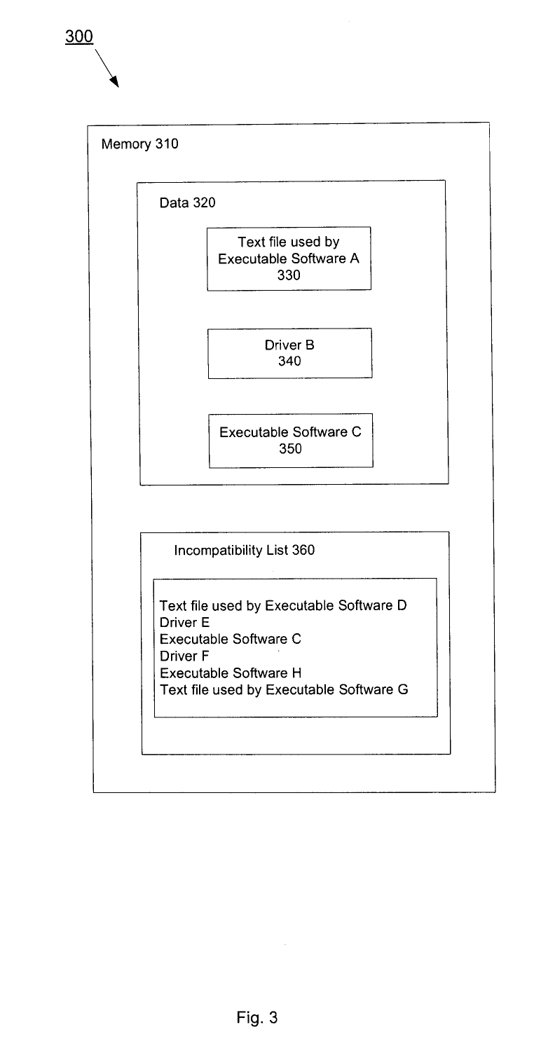

FIG. 3 illustrates an exemplary memory prior to quarantining one or more files associated with non-priority software in accordance with embodiments of the present invention. Referring to FIG. 3, memory 310 contains data 320 and incompatibility list 360. Within data 320, there is text file used by executable software A 330, driver B 340, and executable software C 350. Prior to the quarantining process, data 320 contains text file used by executable software A 330, driver B 340, and executable software C 350, thereby not taking into account any files listed in incompatibility list 360.

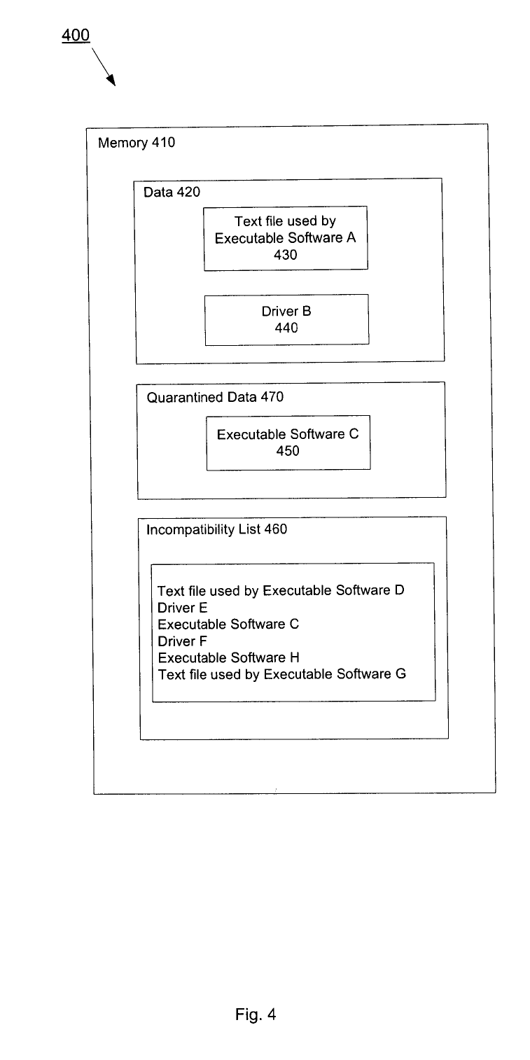

FIG. 4 illustrates an exemplary memory after quarantining one or more files associated with non-priority software in accordance with embodiments of the present invention. Referring to FIG. 4, memory 410 contains data 420, quarantined data 470, and incompatibility list 460. Within data 420, there is text file used by executable software A 430 and driver B 440. After the quarantining process, executable software C 450 can be relocated to quarantined data 470 based on incompatibility list 460. In alternate embodiments, executable software C can remain in data 420 and cannot be relocated to quarantined data 470. In one such alternate embodiment, the file name for executable software C 450 can be modified to include a descriptor which indicates a quarantined state. In another such alternate embodiment, executable software C 450 can be modified to include a designator in the file contents to indicate a quarantined state. In yet another such alternate embodiment, the metadata associated with executable software C 450 can be modified to include a designator to indicate a quarantined state.

FIG. 5 illustrates a flow diagram of a method of quarantining incompatible software in accordance with embodiments of the present invention. In one embodiment, quarantining incompatible software method 500 is performed by incompatibility list downloader 240 and application quarantiner 260.

Referring to FIG. 5, method 500 starts at block 510. At block 510, the process determines whether there is a network available. If a network is not available, the process continues to block 520. At block 520, a pre-existing incompatibility list, or alternate list, can be retrieved. In one embodiment, the pre-existing incompatibility list can identify non-priority software which is incompatible with priority software. In one embodiment, the pre-existing incompatibility list can be obtained from a location accessible to the system, such as a memory. In one embodiment, the incompatibility can be obtained from the installation media on which the priority software also is stored. In this embodiment, the incompatibility list can contain non-priority software which was incompatible with the priority software at the time the priority software to be installed was released. The process then continues to block 550.

In one embodiment, if a network is available, the process continues to block 530. At block 530, an incompatibility list can be downloaded over the network. In one embodiment, the priority software can be downloaded over the network concurrently with the incompatibility list. In one embodiment, once the incompatibility list is downloaded over the network, the incompatibility list can overwrite a pre-existing incompatibility list. In an alternate embodiment, the incompatibility list can augment a pre-existing incompatibility list. In another alternate embodiment, the incompatibility list can change or be merged with a pre-existing incompatibility list. Once the incompatibility list has been downloaded, the process proceeds to block 540.

At block 540, the downloaded incompatibility list can be authenticated and/or verified. In one embodiment, the authentication and verification can be done using the process described below in conjunction with FIG. 6. In certain embodiments, block 540 is optional and is not performed. In certain embodiments, if block 540 is omitted, the process continues to block 550 from block 530.

At block 550, the process installs the priority software. In one embodiment, the priority software can be an operating system. In one embodiment, prior to installing the priority software, any previous software which will be overwritten with the priority software can be removed. In an alternate embodiment, the priority software can be updated or overwritten without being removed. In another alternate embodiment, the priority software can be new to the system. In certain embodiments, block 550 can be optional if the priority software is already installed on the system and does not need to be updated or overwritten. Upon the completion of the installation of the priority software, the process proceeds to block 560.

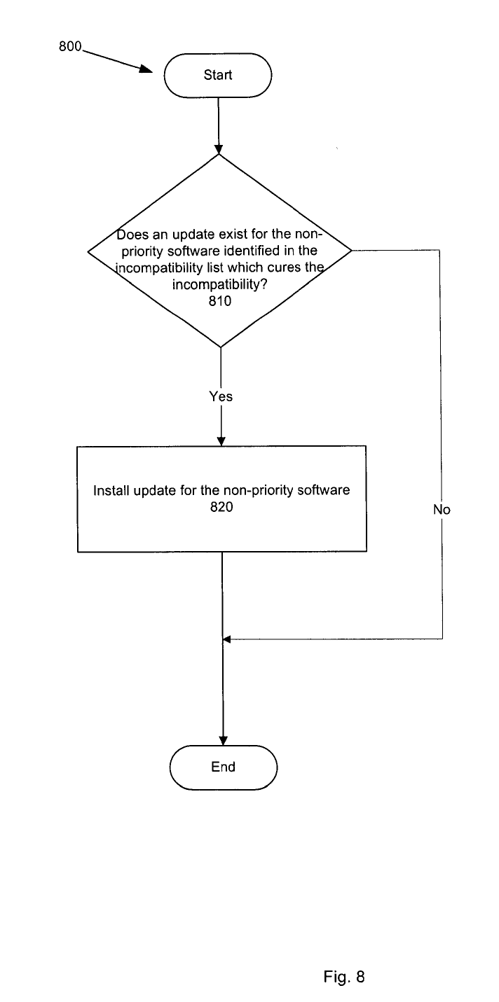

At block 560, a determination is made as to whether the non-priority software from the incompatibility list resides on the system. If the non-priority software does not reside on the system, the process ends. In one embodiment, if the non-priority software resides on the system, a determination can be made as to whether an update exists for the non-priority software which cures the incompatibility. The process for curing an incompatibility is described below in conjunction with FIG. 8. If the non-priority software resides on the system, the process continues to block 570.

At block 570, a file associated with the non-priority software residing on the system is quarantined based on the incompatibility list. In one embodiment, the non-priority software identified in the incompatibility list is comprised of one or more files and is a subset of the one or more quarantined files. In one embodiment, a quarantined file can be relocated to a quarantine location on the system, such that the system does not access or run the file during normal operation. In an alternate embodiment, the name of the quarantined file can be modified to include a descriptor which indicates that the quarantined file is quarantined. In another alternate embodiment, the quarantined file can be modified to include a designator in the file contents to indicate that the quarantined file has been quarantined. In yet another alternate embodiment, the metadata associated with the quarantined file can be modified to include a designator to indicate that the quarantined file has been quarantined. In these alternate embodiments, the system cannot access or run the quarantined file during normal operations. The process then ends.

Method 500 illustrates one implementation of quarantining incompatible software. In alternate embodiments, the order in which the blocks of method 500 are performed can be modified without departing from the scope of the invention. In one embodiment, method 500 can install the priority software prior to quarantining incompatible software. In an alternate embodiment, method 500 can quarantine the incompatible software prior to installing the priority software. In yet another embodiment, the determination of whether a network is available can be made after the priority software is installed.

FIG. 6 illustrates a flow diagram of a method of verifying an incompatibility list in accordance with embodiments of the present invention. Method 600 is a more detailed description of block 540 of FIG. 5. In one embodiment incompatibility list update method 600 can be performed by incompatibility list downloader 240 of FIG. 2.

Referring to FIG. 6, block 610 determines whether the downloaded incompatibility list is authentic. In one embodiment, the incompatibility list can be authentic if a representation of the incompatibility list compares in a predetermined manner (e.g., equivalent) to a representation stored in the system into which the incompatibility list is downloaded. In one embodiment, the representation can be a cryptographic signature. In an alternate embodiment, the representation can be a hash, or any other equivalent representation. If the downloaded incompatibility list is not authentic, the process continues to block 630. If the downloaded incompatibility list is authentic, the process continues to block 620.

At block 620, a determination is made as to whether the downloaded incompatibility list passes a version check. In one embodiment, the version check can determine whether a version number of the downloaded incompatibility list compares in a predetermined manner (e.g., greater than) to a version number of a pre-existing incompatibility list. In an alternate embodiment, the version check can determine whether a time stamp of the downloaded incompatibility list compares in a predetermined manner (e.g., is later than) to a time stamp of a pre-existing incompatibility list. If the downloaded incompatibility list does not pass the version check, the process continues to block 630. If the downloaded incompatibility list passes the version check, the process continues to block 640.

At block 630, the incompatibility list update installation is aborted and the process ends. In one embodiment, as part of aborting the installation, a pre-existing incompatibility list can be obtained from storage. In an alternate embodiment, as part of aborting the installation, the incompatibility list can be obtained from the installation media on which the priority software also is stored. The process then ends.

At block 640, the downloaded incompatibility list is stored in the system. In one embodiment, once the incompatibility list is downloaded over the network, the incompatibility list can overwrite a pre-existing incompatibility list. In an alternate embodiment, the incompatibility list can augment a pre-existing incompatibility list. In another alternate embodiment, the incompatibility list can change or be merged with a pre-existing incompatibility list. The process then ends.

FIG. 7 illustrates a flow diagram of a method of quarantining incompatible software in accordance with embodiments of the present invention. In one embodiment quarantining incompatible software method 700 is performed by application quarantiner 260 of FIG. 2.

Referring to FIG. 7, at block 710, a file associated with non-priority software identified in an incompatibility list is automatically quarantined. In one embodiment, the non-priority software can be applications or portions thereof, other executables, drivers, or text files to be used by executable software. In one embodiment, the non-priority software identified in the incompatibility list is comprised of one or more files and is a subset of the one or more quarantined files. In one embodiment, a quarantined file can be relocated to a quarantine location on the system, such that the system does not access or run the file during normal operation. In an alternate embodiment, the name of the quarantined file can be modified to include a descriptor which indicates that the quarantined file is quarantined. In another alternate embodiment, the quarantined file can be modified to include a designator in the file contents to indicate that the quarantined file has been quarantined. In yet another alternate embodiment, the metadata associated with the quarantined file can be modified to include a designator to indicate that the quarantined file has been quarantined. In these alternate embodiments, the system cannot access or run the quarantined file during normal operations.

At block 720, the priority software is installed. In one embodiment, the priority software can be an operating system. In one embodiment, prior to installing the priority software, any previous software which will be overwritten with the priority software can be removed. In an alternate embodiment, the priority software can be updated or overwritten without being removed. In another alternate embodiment, the priority software can be new to the system. In certain embodiments, block 720 can be optional if the priority software is already installed on the system and does not need to be updated or overwritten. Upon a successful installation of the priority software, the process proceeds to block 730.

At block 730, the user can be notified that a file associated with the non-priority software has been quarantined. In one embodiment, the user can be notified that the file has been quarantined after the system has been restarted. In one embodiment, the user can be notified only once of the quarantined files. In an alternate embodiment, the user can be notified of the quarantined files each time the system boots.

In certain embodiments, block 730 is optional and is not performed. In certain embodiments, if block 730 is omitted, the process ends after block 720.

FIG. 8 illustrates a flow diagram of a method of curing incompatible software in accordance with embodiments of the present invention. In one embodiment curing incompatible software method 800 is performed by application quarantiner 260 of FIG. 2.

Referring to FIG. 8, at block 810, a determination is made as to whether an update exists for the non-priority software identified in the incompatibility list which cures the incompatibility. In one embodiment, the user can be asked whether to update the non-priority software. In one embodiment, the system can periodically check whether an update exists for the non-priority software which cures the incompatibility. In an alternate embodiment, the system can continuously check for an update for the non-priority software. If an update does not exist that cures the incompatibility, the process ends. If an update exists which cures the incompatibility, the process continues to block 820.

At block 820, the update for the non-priority software which cures the incompatibility is installed. The process then ends.

Method 800 can be performed prior to quarantining one or more files associated with the non-priority software or can be performed once the one or more files associated with the non-priority software have been quarantined.

The methods as described herein are not described with reference to any particular programming language. It will be appreciated that a variety of programming languages may be used to implement the teachings of the present invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result. It will be further appreciated that more or fewer processes may be incorporated into the methods 500, 600, 700, and 800 in FIG. 5, FIG. 6, FIG. 7, and FIG. 8 respectively without departing from the scope of the invention and that no particular order is implied by the arrangement of blocks shown and described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method comprising:
obtaining, from an external source, an incompatibility list that identifies non-priority software incompatible with priority software to be installed or already installed on a system;
determining whether the non-priority software from the incompatibility list resides on the system; and
automatically quarantining one or more files associated with the non-priority software identified in the incompatibility list and residing on the system.

2. The method of claim 1, wherein the non-priority software identified in the incompatibility list comprises one or more files and is a subset of the one or more quarantined files.

3. The method of claim 1, wherein the non-priority software comprises at least one of: an application, a portion of an application, a driver, an executable software, and a text file to be used by an executable software.

4. The method of claim 1, wherein obtaining the incompatibility list comprises:
determining whether a network is available; and
responsive to a network being available,
downloading the incompatibility list over the network, and
verifying the incompatibility list.

5. The method of claim 4, further comprising:
responsive to a network not being available, obtaining the incompatibility list from at least one of a pre-existing incompatibility list and media on which the priority software is stored.

6. The method of claim 4, wherein verifying the incompatibility list comprises one or more of checking whether the incompatibility list compares in a predetermined manner to a pre-existing incompatibility list, checking whether the incompatibility list compares in a predetermined manner to an incompatibility list from media on which the priority software is stored, and authenticating the incompatibility list, wherein the authenticating checks that a representation of the incompatibility list compares in a predetermined manner to a stored representation.

7. The method of claim 1, further comprising:
determining whether an update exists for the non-priority software, wherein the update cures a incompatibility between the non-priority software and the priority software.

8. A method comprising:
determining whether a network is available for a system;
responsive to a network being available, downloading an incompatibility list over the network, the incompatibility list identifying non-priority software incompatible with priority software to be installed or already installed on a system; and
installing the priority software on the system.

9. The method of claim 8, further comprising:
responsive to the network being available,
determining whether the non-priority software identified in the incompatibility list resides on the system, and
automatically quarantining one or more files associated with the non-priority software identified in the incompatibility list and residing on the system; and
responsive to the network not being available,
determining whether non-priority software from a alternate list resides on the system, wherein the non-priority software identified in the alternate list is incompatible with the priority software, and
automatically quarantining one or more files associated with the non-priority software identified in the alternate list and residing on the system.

10. The method of claim 8, further comprising:
verifying the incompatibility list, wherein verifying the incompatibility list comprises one or more of checking whether the incompatibility list compares in a predetermined manner to a pre-existing list, checking whether the incompatibility list compares in a predetermined manner to a list from media on which the priority software is stored, and authenticating the incompatibility list, wherein the authenticating checks that a representation of the incompatibility list compares in a predetermined manner to a stored representation.

11. The method of claim 9, wherein the non-priority software identified in the incompatibility list comprises one or more files and is a subset of the one or more quarantined files associated with the non-priority software identified in the incompatibility list, and wherein the non-priority software identified in the alternate list comprises one or more files and is a subset of the one or more quarantined files associated with the non-priority software identified in the alternate list.

12. The method of claim 9, wherein the alternate list is obtained from at least one of a pre-existing list or a media on which the priority software is stored.

13. The method of claim 9, wherein the non-priority software comprises at least one of: an application, a portion of an application, a driver, an executable software, and a text file to be used by an executable software.

14. The method of claim 9, further comprising:
responsive to the network being available, determining whether an incompatibility update exists for the non-priority software identified in the incompatibility list, wherein the incompatibility update cures an incompatibility between the non-priority software identified in the incompatibility list and the priority software; and
responsive to the network not being available, determining whether an alternate update exists for the non-priority software identified in the alternate list, wherein the alternate update cures an incompatibility between the non-priority software identified in the alternate list and the priority software.

15. A computer-readable storage medium comprising executable instructions to cause a processor to perform operations, the instructions comprising:
obtaining, from an external source, an incompatibility list that identifies non-priority software incompatible with priority software to be installed or already installed on a system;
determining whether the non-priority software from the incompatibility list resides on the system; and
automatically quarantining one or more files associated with the non-priority software identified in the incompatibility list and residing on the system.

16. The computer-readable storage medium of claim 15, wherein the non-priority software comprises at least one of: an application, a portion of an application, a driver, an executable software, and a text file to be used by an executable software.

17. The computer-readable storage medium of claim 15, wherein obtaining the incompatibility list comprises:
determining whether a network is available; and
responsive to a network being available,
downloading the incompatibility list over the network, and
verifying the incompatibility list.

18. The computer-readable storage medium of claim 16, further comprising:
responsive to a network not being available, obtaining the incompatibility list from at least one of a pre-existing incompatibility list and a media on which the priority software is stored.

19. The computer-readable storage medium of claim 17, wherein verifying the incompatibility list comprises one or more of checking whether the incompatibility list compares in a predetermined manner to a pre-existing incompatibility list, checking whether the incompatibility list compares in a predetermined manner to an incompatibility list from media on which the priority software is stored, and authenticating the incompatibility list, wherein the authenticating checks that a representation of the incompatibility list compares in a predetermined manner to a stored representation.

20. A computer-readable storage medium comprising executable instructions to cause a processor to perform operations, the instructions comprising:
determining whether a network is available for a system;
responsive to a network being available, downloading an incompatibility list over the network, the incompatibility list identifying non-priority software incompatible with priority software to be installed or already installed on a system; and
installing the priority software on the system.

21. The computer-readable storage medium of claim 20, wherein the instructions further comprise:
responsive to the network being available,
determining whether the non-priority software identified in the incompatibility list resides on the system, and
automatically quarantining one or more files associated with the non-priority software identified in the incompatibility list and residing on the system; and responsive to the network not being available,
determining whether non-priority software from a alternate list resides on the system, wherein the non-priority software identified in the alternate list is incompatible with the priority software, and
automatically quarantining one or more files associated with the non-priority software identified in the alternate list and residing on the system.

22. The computer-readable storage medium of claim 20, wherein the instructions further comprise:
verifying the incompatibility list, wherein verifying the incompatibility list comprises one or more of checking whether the incompatibility list compares in a predetermined manner to a pre-existing list, checking whether the incompatibility list compares in a predetermined manner to a list from media on which the priority software is stored, and authenticating the incompatibility list, wherein the authenticating checks that a representation of the incompatibility list compares in a predetermined manner to a stored representation.

23. The computer-readable storage medium of claim 21, wherein the non-priority software identified in the incompatibility list comprises one or more files and is a subset of the one or more quarantined files associated with the non-priority software identified in the incompatibility list, and wherein the non-priority software identified in the alternate list comprises one or more files and is a subset of the one or more quarantined files associated with the non-priority software identified in the alternate list.

24. The computer-readable storage medium of claim 21, wherein the alternate list is obtained from at least one of a pre-existing list and a media on which the priority software is stored.

25. The computer-readable storage medium of claim 20, wherein the non-priority software comprises at least one of an application, a portion of an application, a driver, an executable software, and a text file to be used by an executable software.

26. An apparatus comprising:
means for obtaining, from an external source, an incompatibility list that identifies non-priority software incompatible with priority software to be installed or already installed on a system;
means for determining whether the non-priority software from the incompatibility list resides on the system; and
means for automatically quarantining one or more files associated with the non-priority software identified in the incompatibility list and residing on the system.

27. An apparatus comprising:
means for determining whether a network is available for a system;
responsive to a network being available, means for downloading an incompatibility list over the network, the incompatibility list identifying non-priority software incompatible with priority software to be installed or already installed on a system; and
means for installing the priority software on the system.

28. A computer system comprising:
a memory; and
a processor configurable by instructions stored in the memory to:
obtain, from an external source, an incompatibility list that identifies non-priority software incompatible with priority software to be installed or already installed on a system;
determine whether the non-priority software from the incompatibility list resides on the system; and
automatically quarantine one or more files associated with the non-priority software identified in the incompatibility list and residing on the system.

29. A computer system comprising:
a memory; and
a processor configurable by instructions stored in the memory to:
determine whether a network is available for a system;
responsive to a network being available, download an incompatibility list over the network, the incompatibility list identifying non-priority software incompatible with priority software to be installed or already installed on a system; and
install the priority software on the system.
